(19) United States
(12) Patent Application Publication
(10) Pub. No.: US 2025/0304215 A1
(43) Pub. Date: Oct. 2, 2025

(54) BOAT ANCHOR AND WINCH ASSEMBLY

(71) Applicant: LONE STAR MARINE PTY LTD, Carrum Downs, Victoria (AU)

(72) Inventor: Malki Allen Aboud ARY, Victoria (AU)

(21) Appl. No.: 18/864,874

(22) PCT Filed: May 8, 2023
(86) PCT No.: PCT/AU2023/050382

§ 371 Date: Nov. 11, 2024

(30) Foreign Application Priority Data
May 9, 2022 (AU) 2022901235

(51) Int. Cl. B63B 21/16; B63B 21/10; B63B 21/22; B66D 1/12; B66D 1/36; B66D 1/72

(52) U.S. Cl. CPC B63B 21/16; B63B 21/10; B63B 21/22; B66D 1/12; B66D 1/36; B66D 1/72

(57) ABSTRACT

A boat winch assembly including a mounting bracket for securing the assembly to a boat, a winch subassembly supported by the mounting bracket and including a spool for an anchor line, and a drive motor for rotating the spool, a spar having an outer end with one or more rollers, an anchor line retaining member, and a fairlead that is defined between one of the rollers and the anchor line retaining member, wherein in use, the anchor line passes through the fairlead, and a hinge connection, such that the spar projects outwardly from the hinge connection, where the hinge connection enables the spar to rotate between a deployed position and a stowed position and when the boat winch assembly is secured to a boat, inclination of the spar increases with rotation of the spar about the pivot axis from the deployed position towards the stowed position.

### FIELD OF THE INVENTION

The present invention relates to a boat anchor and winch assembly, and to a boat anchor.

### BACKGROUND

It is known to use winches for boat anchors to simplify the task of anchor retrieval. The boat winch has the benefits of high power from the winch motor (arising from both torque and speed), and of mechanical advantage provided through the winch gearbox.

A drum winch is a particular style of winch that winds an anchor line (such as, chain, and/or rope) onto a drum, or spool. Drum winches are useful on vessels that do not have an anchor locker in which to store the anchor line beneath the deck. Typically, drum winches are used on smaller vessels that are used for recreational purposes.

On vessels where the anchor line crosses the deck, it is necessary to protect the deck, hull, bow, and gunwales from contact with the anchor line, while at anchor, and also when raising and lowering the anchor. To prevent damage, it common to install an anchor bowsprit on the deck of the vessel at the bow and projecting outwardly from the deck. Anchor bowsprits typically have a mounting base with sides that form a channel, and a head formed at the outer end. One or more rollers are provided at the head to facilitate passage of the anchor line over and along the bowsprit. Some anchor bowsprits include a retaining pin, saddle strap, or similar retainer at the head to ensure the anchor line follows a predetermined path through the channel, and to hold the anchor at the head.

The consequence of the bowsprit projecting outwardly beyond the bow/gunwale of the vessel, is that when the vessel is in a berth a “gap” is present between the deck of the vessel and the landing structure (such as a jetty, walkway, landing stage, etc.) and in the region of the bowsprit. The gap creates difficulties with embarkation and disembarkation. An anchor bowsprit may also be known by other names, including “bow roller”.

It is also known that the ability of any anchor to hold is dependent on many factors, including the form of the anchor, the composition of the bed of the body of water into which the anchor is set, the weight of the anchor line (particularly where the line is, or includes a chain to which the anchor is connected), and the size of the vessel. There are many different forms of anchors. Some anchors, known as “fluked anchors”, use flukes that are to dig into bed material at the bottom of the body of water to maximize the holding power of the anchor. This type of anchor generally has a shank with an upper end for attachment to an anchor line, and one or more flukes at the lower end of the shank.

Many fluked anchors have limited holding power in soft bed materials, such as mud and silt, where the anchor tends to drag in response to force on the anchor line, rather than increase embedment. Where the bed material is soft, it is known to use anchors that rely on suction between the anchor head and the bed material to hold the anchor. A mushroom anchor has the general shape of an inverted mushroom, with an inverted-dome head that settles in the bed material. The holding power of a mushroom anchor increases with increasing diameter of the head. However, the force required to raise the anchor also increases with increasing diameter of the head; the increased cross-sectional area of the head requires more water to be displaced when raising the head, and also provides more area on which to retain bed material, which adds to the mass to be retrieved.

There is a need to address the above, and/or at least provide a useful alternative.

### SUMMARY

The present invention provides an anchor bowsprit comprising:
a mounting bracket for securing the anchor bowsprit to a boat;
a spar with an inner end, an outer end, and a lengthwise direction extending from the inner end to the outer end, the outer end of the spar having:
   one or more rollers,
   an anchor line retaining member, and
   a fairlead that is defined between one of the rollers and the anchor line retaining member, whereby in use of the anchor bowsprit, an anchor line is to pass through the fairlead; and
a hinge connection at the inner end of the spar interconnects the spar with the mounting bracket, such that the spar projects outwardly from the hinge connection, the hinge connection enabling the spar to rotate relative to the mounting bracket between a deployed position and a stowed position about a pivot axis that is generally transverse to the lengthwise direction of the spar,
wherein, when the anchor bowsprit is secured to a boat, inclination of the spar increases with rotation of the spar about the pivot axis from the deployed position towards the stowed position.

In certain examples, the anchor bowsprit is configured to be used with an anchor having a head connected to a shank that has a predetermined maximum diameter, and the fairlead is shaped to permit at least an upper end portion of the shank to pass through the fairlead. Preferably, the outer end of the spar has an abutment formation that is configured such that the head of the anchor can abut the outer surface of the abutment formation, with the shank extending through the fairlead. Even more preferably, the abutment formation is configured such that, when the head is in contact with the outer surface of the abutment formation and the shank is extending through the fairlead, the shank is inclined relative to the lengthwise direction of the spar.

In at least some examples, the spar is displaceable about the pivot axis by at least 15° between the deployed and stowed positions. Preferably, the spar is displaceable about the pivot axis by at least 30° between the deployed and stowed positions. Preferably, the spar is displaceable about the pivot axis by at least 45° between the deployed and stowed positions. In certain examples, the spar is displaceable about the pivot axis by approximately 50° between the deployed and stowed positions.

Alternatively or additionally, the anchor bowsprit is configured such that when secured to a boat and with the spar in the stowed position, gravity causes the spar to move to the deployed position absent any other forces acting on the spar.

The mounting bracket can include a pair of side walls and a base plate that extends between, and spaces apart the side walls,
wherein the hinge connection includes a hinge pin that extends between the side walls, and interconnects the spar and the mounting bracket to thereby define the pivot axis.

Preferably, the plate includes mounting holes for use in securing the anchor bowsprit to a boat.

In certain examples, the spar has a centre plate, and a pair of uprights, wherein each upright includes a knuckle hole through which the hinge pin extends.

The centre plate has an upper surface and a lower surface between the inner and outer ends, the lower surface of the spar includes an inner end portion that is generally planar, the inner end portion of the lower surface is parallel to the base plate when the spar is in the deployed position.

Alternatively or additionally, the lower surface of the centre plate includes an inner end portion, and an underside of the base plate defines a mounting surface, and
wherein when the spar is in the deployed position the inner end portion is offset from the mounting surface.

Preferably, at the outer end of the spar, outer portions of the uprights project in the lengthwise direction outwardly beyond the centre plate, and at least partly form the abutment formation. The rollers and anchor line retaining member can be interconnected with the outer portions of the uprights.

The uprights are generally at right angles to the centre plate, and extend away from the upper surface of the centre plate. In this way, a channel-like formation is defined by the upper surface of the centre plate, and the inwardly oriented faces of the uprights.

In at least some examples, the outer portion of each upright includes an end face that is partially oblique to the lengthwise direction of the spar. Preferably, the outer portion of each upright includes a curved portion adjacent the end face.

Preferably, the width of the spar narrows in the lengthwise direction towards the outer end.

Preferably, the mounting bracket has a first stop that engages with the spar to limit rotation of the spar in a first direction about the pivot axis to thereby define the deployed position. In some examples, the first stop is integrally formed with the mounting bracket.

Alternatively or additionally, the mounting bracket has a second stop that engages with the spar to limit rotation of the spar in a second direction about the pivot axis to thereby define the stowed position. In some examples, the second stop includes a bar that extends between the side walls.

The spar can additionally include a stop plate that is disposed to contact the bar when the spar is in the stowed position.

The present invention also provides a boat winch assembly comprising:
a mounting bracket for securing the assembly to a boat;
a winch subassembly that is supported by mounting bracket, and includes a spool onto which an anchor line is to be wound, and a drive motor for rotating the spool;
a spar with an inner end, an outer end, and a lengthwise direction extending from the inner end to the outer end, the outer end of the spar having:
   one or more rollers,
   an anchor line retaining member, and
   a fairlead that is defined between one of the rollers and the anchor line retaining member, whereby in use of the boat winch assembly, an anchor line is to pass through the fairlead; and
a hinge connection at the inner end of the spar interconnects the spar with the mounting bracket, such that the spar projects outwardly from the hinge connection, the hinge connection enabling the spar to rotate relative to the mounting bracket between a deployed position and a stowed position about a pivot axis that is generally transverse to the lengthwise direction of the spar,
wherein, when the boat winch assembly is secured to a boat, inclination of the spar increases with rotation of the spar about the pivot axis from deployed position towards the stowed position.

In certain examples, the boat winch assembly is configured to be used with an anchor having a head connected to a shank with a predetermined maximum diameter, and the fairlead is shaped to permit at least an upper end portion of the shank to pass through the fairlead. Preferably, the outer end of the spar has an abutment formation that is configured such that the head of the anchor can abut an outer surface of the abutment formation, with the shank extending through the fairlead.

Preferably, the boat winch assembly is configured such that, when:
the anchor is in contact with the outer surface of the abutment formation,
at least part of the shank extends through the fairlead,
the spar is in the deployed position, and
the portion of the anchor line that is between the spool and the shank is taut,

operation of the winch subassembly to wind anchor line onto the spool causes the spar to move towards the stowed position.

Preferably, the abutment formation is configured such that, when the head is in contact with the outer surface and the shank is extending through the fairlead, the shank is inclined relative to the lengthwise direction of the spar.

In at least some examples, the spar is displaceable about the pivot axis by at least 15° between the deployed and stowed positions. Preferably, the spar is displaceable about the pivot axis by at least 30° between the deployed and stowed positions. Preferably, the spar is displaceable about the pivot axis by at least 45° between the deployed and stowed positions. In certain examples, the spar is displaceable about the pivot axis by approximately 50° between the deployed and stowed positions.

Alternatively or additionally, the boat winch assembly is configured such that when secured to a boat and with the spar in the stowed position, gravity causes the spar to move to the deployed position absent any other forces acting on the spar.

In some examples, the mounting bracket includes a pair of side walls and a base plate that extends between and spaces apart the side walls,
wherein the hinge connection includes a hinge pin that extends between the side walls, and interconnects the spar and the mounting bracket to thereby define the pivot axis.

Preferably, the base plate includes mounting holes for use in securing the boat winch assembly to a boat.

In certain examples, the spar has a centre plate, and a pair of uprights, wherein each upright includes a knuckle hole through which the hinge pin extends.

The centre plate has an upper surface and a lower surface between the inner and outer ends, the lower surface of the spar includes an inner end portion that is generally planar, the inner end portion of the lower surface is parallel to the base plate when the spar is in the deployed position.

Alternatively or additionally, the lower surface of the spar includes an inner end portion, and the underside of the base plate has a mounting surface, and
wherein when the spar is in the deployed position the inner end portion is offset from the mounting surface.

The uprights are generally at right angles to the centre plate, and extend away from the upper surface of the centre plate. In this way, a channel-like formation is defined by the upper surface of the centre plate, and the inwardly oriented faces of the uprights.

Preferably, at the outer end of the spar, outer portions of the uprights project in the lengthwise direction outwardly beyond the centre plate, and at least partly form the abutment formation The rollers and anchor line retaining member can be interconnected with the outer portions of the uprights.

In at least some examples, the outer portion of each upright includes an end face that is partially oblique to the lengthwise direction of the spar. Preferably, the outer portion of each upright includes a curved portion adjacent the end face.

Preferably, the width of the spar narrows in the lengthwise direction towards the outer end.

Preferably, the mounting bracket has a first stop that engages with the spar to limit rotation of the spar in a first direction about the pivot axis to thereby define the deployed position. In some examples, the first stop is integrally formed with the mounting bracket.

Alternatively or additionally, the mounting bracket has a second stop that engages with the spar to limit rotation of the spar in a second direction about the pivot axis to thereby define the stowed position. In some examples, the second stop includes a bar that extends between the side walls.

The spar can additionally include a stop plate that is disposed to contact the bar when the spar is in the stowed position.

The present invention also provides an anchor comprising:
a shank with a lower end, and an upper end that includes an attachment point for use in securing the anchor to an anchor line; and
a head at the lower end of the shank, the head including an outer surface that is at least partly convex, and a dome-shaped portion at the lower end of the shank, the dome-shaped portion defines at least part of the outer surface of the head, and an inner surface that faces towards the upper end of the shank,
wherein the anchor is shaped to be in an unstable condition when placed on a horizontal planar surface with the outer surface in contact with that surface and with the shank extending vertically, and is configured to have a stable condition when the outer surface of the head is in contact with a horizontal planar surface and with the shank extending obliquely to vertical.

Preferably, the anchor is configured so that when placed on the horizontal planar surface with the outer surface in contact with that surface and with the shank extending vertically, the anchor will roll on outer surface and then come to rest in the stable condition.

In at least some embodiments, the anchor is configured such that a portion of the peripheral edge of the head is to contact with horizontal planar surface when the anchor is in the stable condition.

In at least some examples, the outer surface of the head includes a central region that is opposite the shank, and wherein the curvature of the central region is such that the anchor is unstable when placed on a horizontal planar surface with the central region contacting that horizontal planar surface. Further, the anchor is configured such the radial centre of the outer surface is not in contact with the horizontal planar surface, when the anchor is in the stable condition.

In certain embodiments, the head further includes a flared portion that extends from the dome-shaped portion, and in which at least the outer surface of the head flares outwardly. Preferably, the peripheral edge of the head forms a perimeter of the flared portion.

In certain embodiments, the anchor is configured such that the anchor is supported at the peripheral edge and at a point that is between the peripheral edge and the radial centre of the head, when the anchor is in the stable condition.

The outer surface of the head can have a shape that is defined by a cubic Bézier curve that is revolved around the longitudinal axis of the shank, an end point of that cubic Bézier curve being coincident with the longitudinal axis.

In at least some examples, the peripheral edge of the head includes:
radially outermost edge portions, and
indented portions that are each positioned between an adjacent pairs of the radially outermost edge portions,
wherein the arrangement of radially outermost edge portions and indented portions define fluke-like formations in the head.

In some examples, each of the radially outermost edge portions is curved. Preferably, each of the radially outermost edge portions is a circular segment.

In certain examples, the peripheral edge has three radially outermost edge portions and three indented portions that collectively define three fluke-like formations in the head.

The inner surface of the dome-shaped portion can be concave in the direction of the attachment point of the shank.

In some examples, the thickness of the head in the direction that is orthogonal to the outer surface reduces towards the peripheral edge. In some particular examples, the thickness of the head in the direction that is orthogonal to the outer surface reduces in regions that are adjacent the radially outermost edge portions.

Preferably, the head includes one or more discharge holes that extend through the dome-shaped portion.

Preferably, the inner surface of the head in portions surrounding each discharge hole is chamfered. In some alternative examples, the inner surface of the head in regions surrounding each discharge hole is bevelled.

Alternatively or additionally:
each portion of the inner surface of the head that is between the shank and a respective one of the discharge holes is curved and convex;
each portion of the inner surface of the head that extends between two adjacent discharge holes is curved and convex; and/or
each portion of the inner surface of the head that is adjacent each of the discharge holes and is radially outward of the shank is curved and convex.

Preferably, the anchor has the same number of discharge holes as the number of indented portions.

Even more preferably, the discharge holes are equally spaced in the circumferential direction about the head, and/or the indented portions are equally spaced in the circumferential direction about the head. In at least some examples, the discharge holes and indented portions are offset from one another in the circumferential direction.

The present invention also provides a kit comprising:
a boat winch assembly, as previously described; and
an anchor, as previously described.

The kit can further comprise an anchor line, with a first end that is to be secured about, or to the spool, and a second end that is to be secured to the attachment point of the anchor.

The anchor line can be rope and/or chain. In some preferred forms, the anchor line includes a length of chain from the second end to an intermediate position along the length of the anchor line, and a length of rope from the intermediate position to the first end.

### BRIEF DESCRIPTION OF THE DRAWINGS

In order that the invention may be more easily understood, embodiments will now be described, by way of example only, with reference to the accompanying drawings, in which:

FIG. 1: is a rear perspective view of a boat winch assembly and anchor according to embodiments of the present invention;

FIG. 2: is a front perspective view of the boat winch assembly shown in FIG. 1, with the spar of the assembly shown in a stowed position;

FIG. 3: is an enlarged view of Region B in FIG. 2;

FIG. 4: is a rear perspective view of the boat winch assembly of FIG. 2;

FIG. 5: is a vertical cross section view of the boat winch assembly, as viewed along the line V-V of FIG. 4;

FIG. 6: is a vertical cross section view of the boat winch assembly, corresponding with FIG. 5 and showing the spar in a deployed position;

FIG. 7: is an enlarged partial view of Region C in FIG. 2;

FIG. 8: is a schematic left side elevation of the boat winch assembly and anchor of FIG. 1, showing the spar and anchor in each of the stowed and deployed positions;

FIG. 9: is a left side elevation showing schematically a pontoon boat that includes the boat winch assembly and anchor of FIG. 1, and showing the spar in the stowed position;

FIG. 10: is an enlarged view of Region D in FIG. 9;

FIG. 11: is a left side elevation showing schematically the pontoon boat of FIG. 9, and showing the spar in the deployed position, and with the anchor set;

FIG. 12: is an enlarged partial view of Region A in FIG. 1;

FIG. 13: is an upper perspective view of the anchor shown in FIG. 1;

FIG. 14: is a first side elevation of the anchor of FIG. 13;

FIG. 15: is a second side elevation of the anchor of FIG. 13;

FIG. 16: is a top view of the anchor of FIG. 13;

FIG. 17: is a bottom view of the anchor of FIG. 13;

FIG. 18: is a side view showing schematically the anchor of FIG. 13 at rest on a horizontal planar surface;

FIG. 19: is a side elevation of the anchor as shown in FIG. 18, and as viewed in the direction F-F;

FIG. 20: is a side view showing schematically the anchor of FIG. 13 set into a river bed;

FIG. 21: is a vertical cross section of the anchor, as viewed along the line W-W in FIG. 14;

FIG. 22: is a vertical cross section of the anchor, as viewed along the line X-X in FIG. 15;

FIG. 23: is a vertical cross section of the anchor, as viewed along the line Y-Y in FIG. 15; and

FIG. 24: is a vertical cross section of the anchor, as viewed along the line Z-Z in FIG. 15.

### DETAILED DESCRIPTION

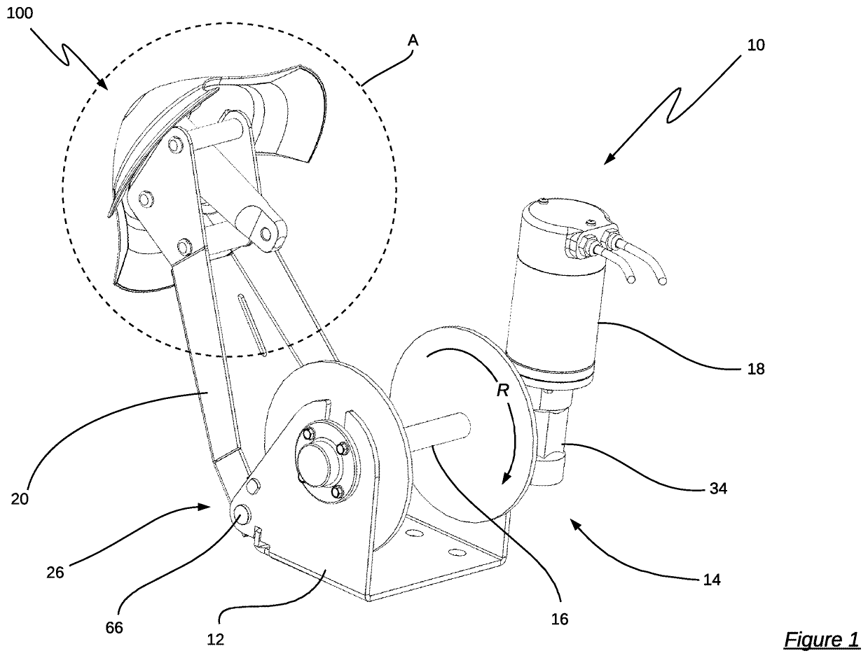

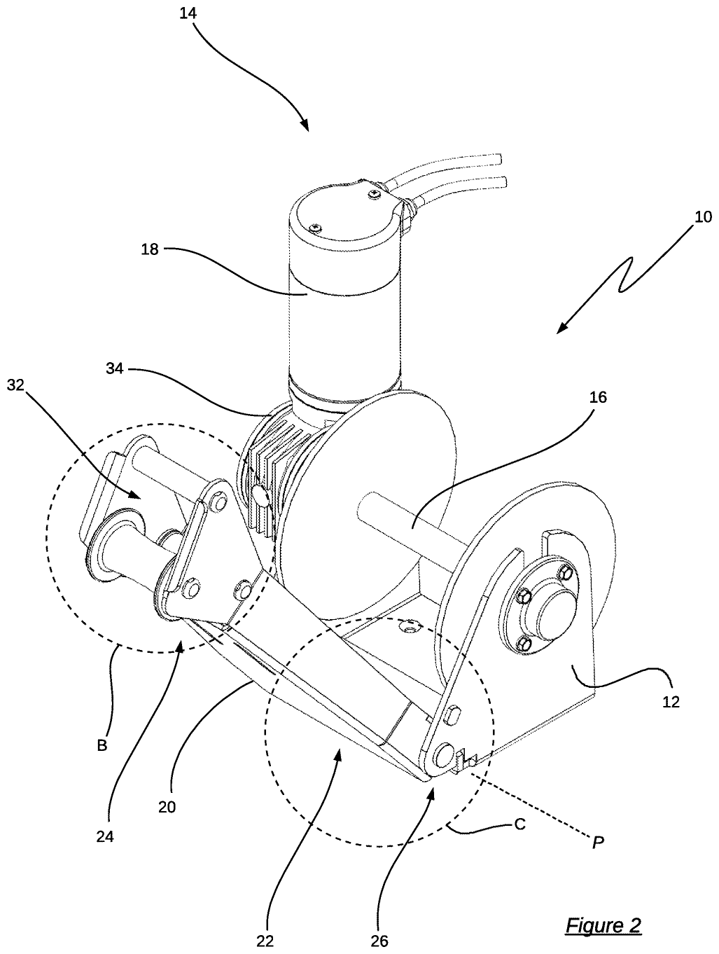

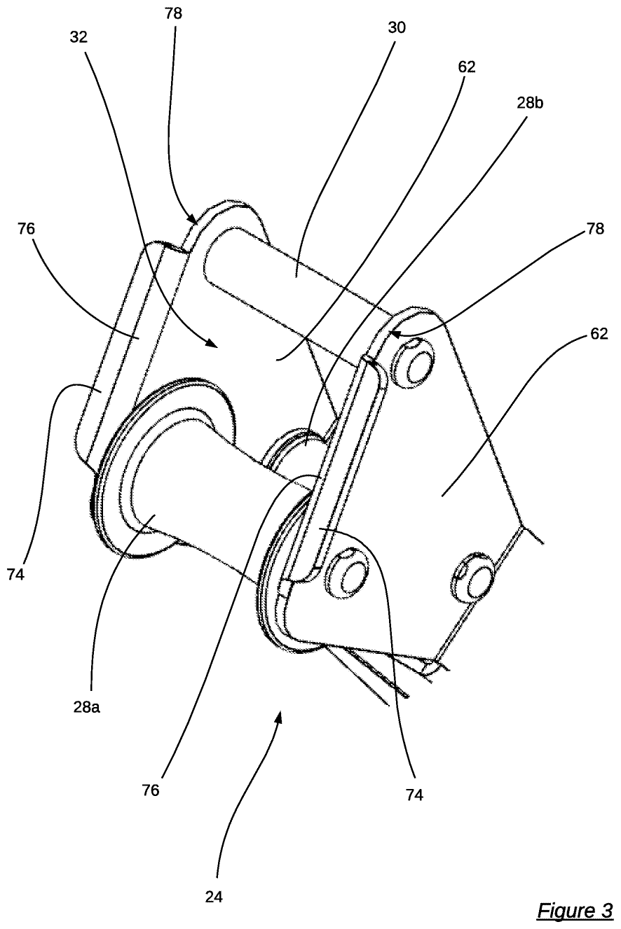

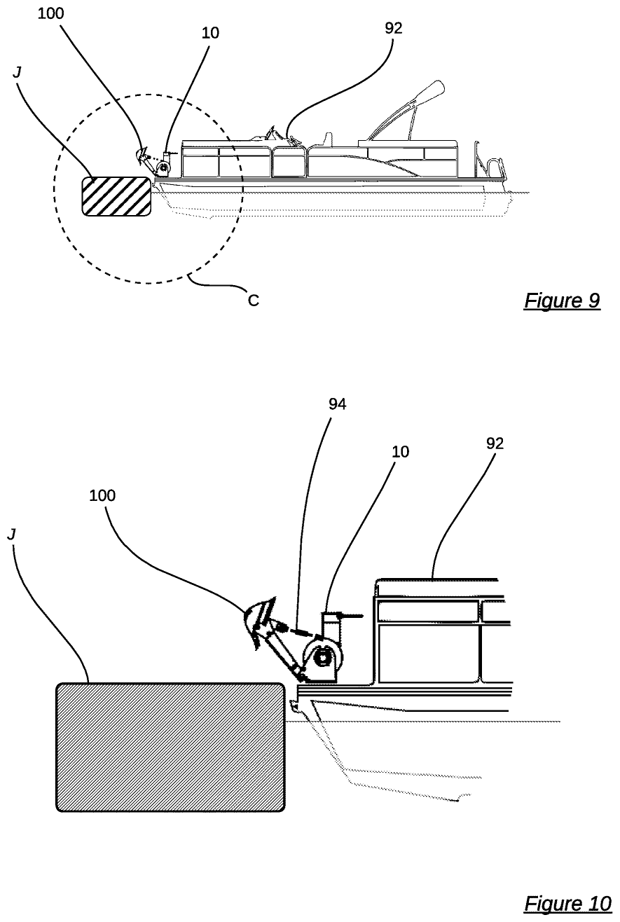

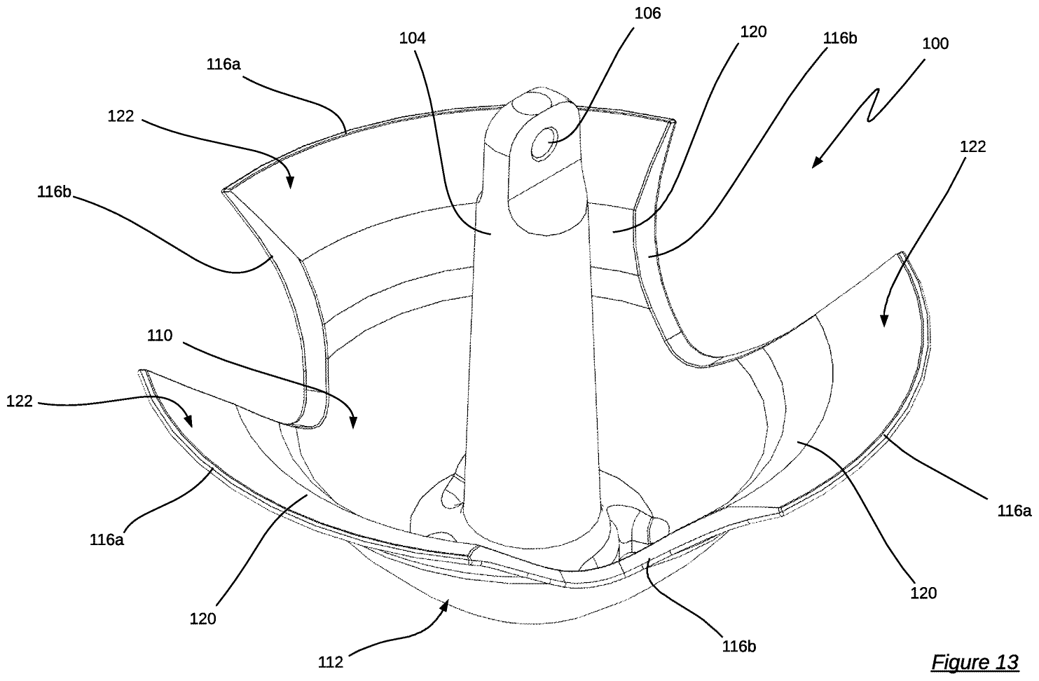

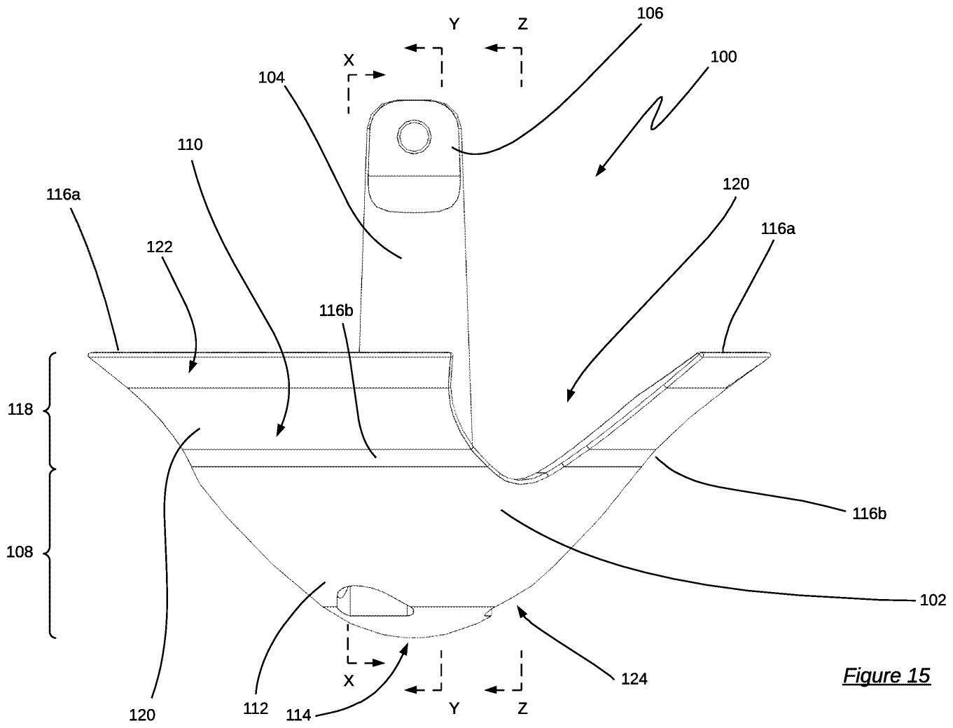

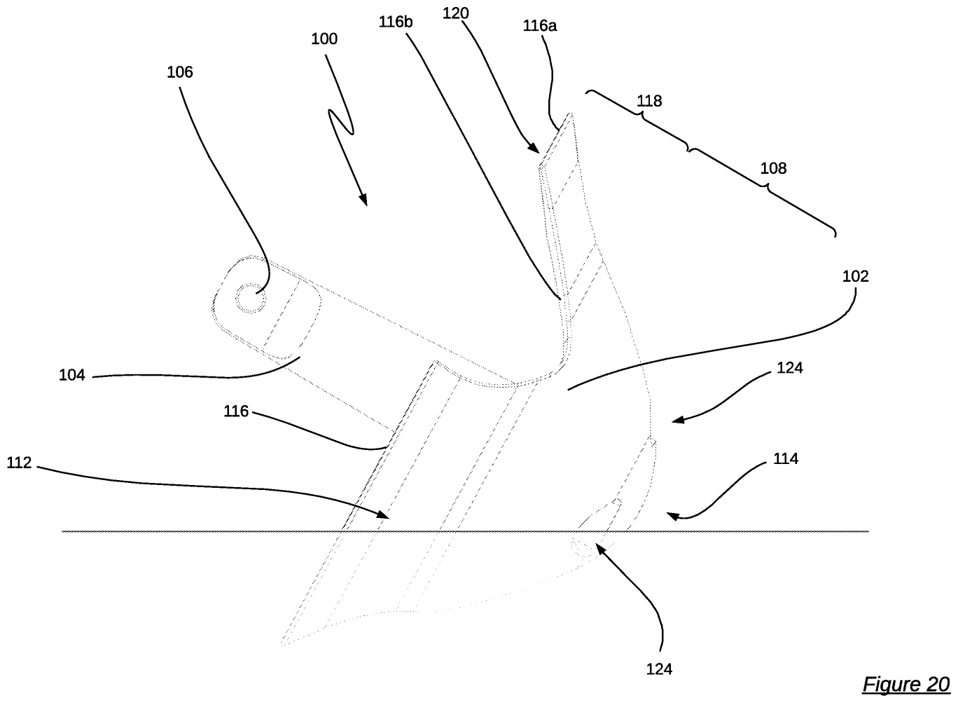

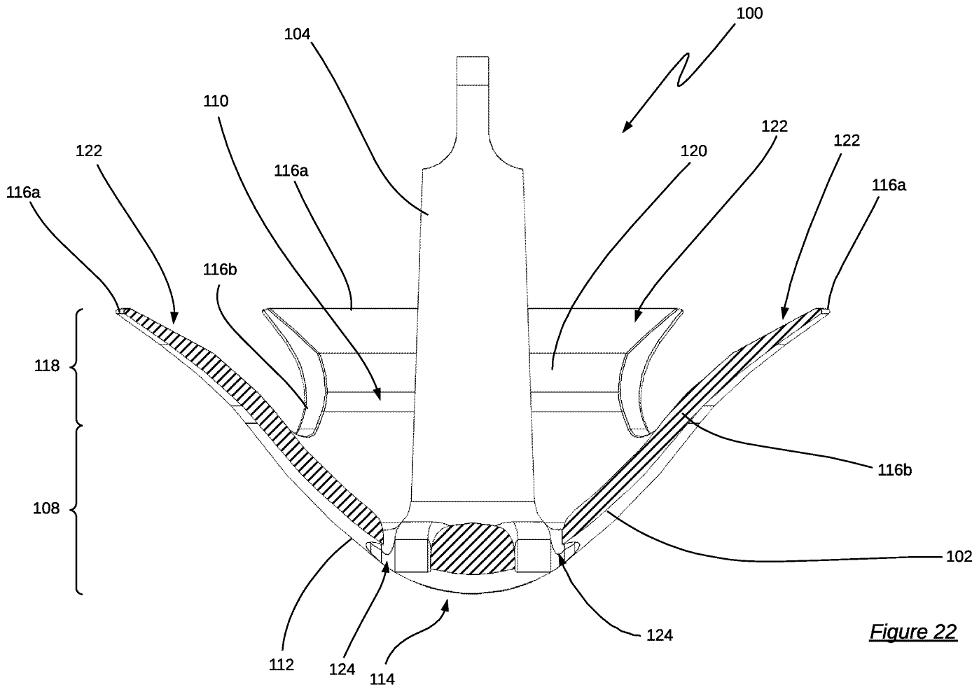

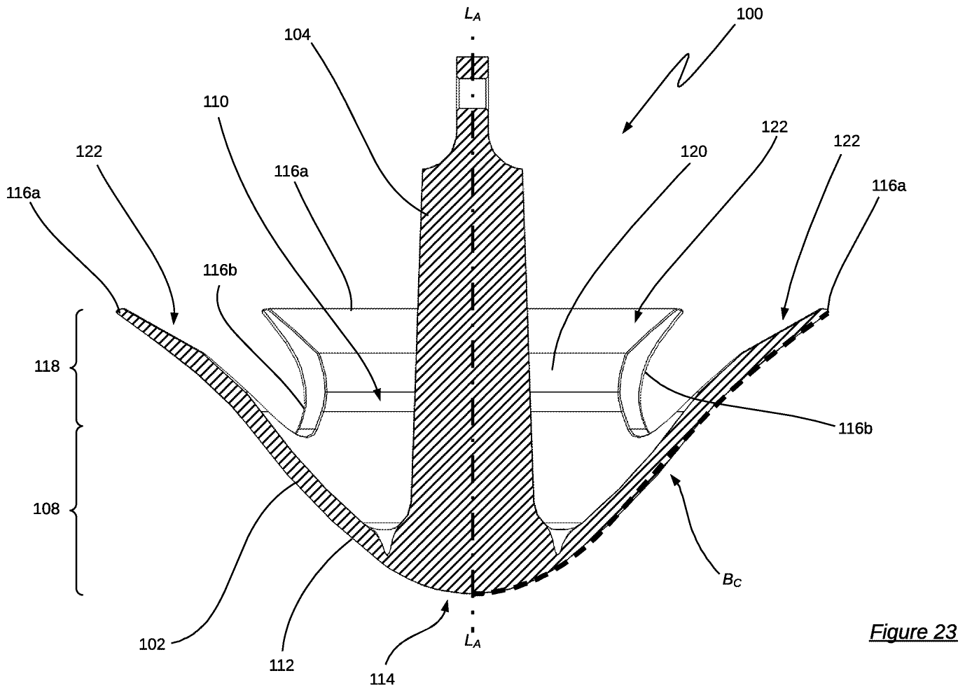

FIGS. 1, 8 and 12 show a boat winch assembly 10, and an anchor 100. The boat winch assembly 10 is shown in further detail in FIGS. 2 to 7. The anchor 100 is shown in further detail in FIGS. 13 to 24, and described in further detail below. FIGS. 9 to 11 show schematically the boat winch assembly 10 secured to a boat 92, and an anchor line 94 connects the anchor 100 to the boat winch assembly 10.

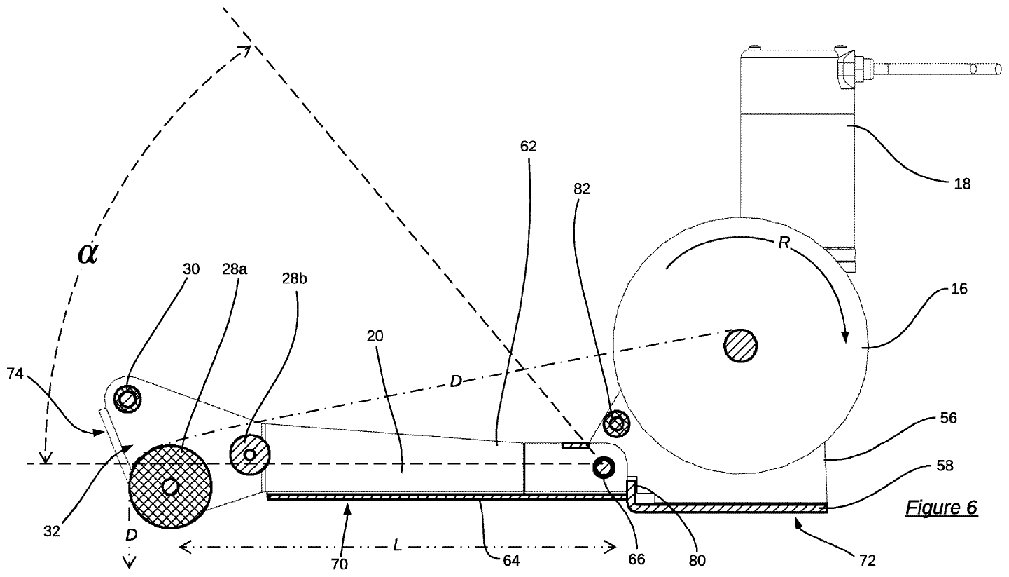

The boat winch assembly 10 has a mounting bracket 12 for securing the boat winch assembly 10 to a boat. A winch subassembly 14 is supported by mounting bracket 12, and includes a spool 16 onto which an anchor line is to be wound, and a drive motor 18 for rotating the spool 16. In FIG. 6, the location of the anchor line is illustrated schematically by a dash-dot line D. In FIGS. 1 and 6, the direction of rotation of the spool 16 to wind the anchor line onto the spool 16 is indicated by arrow R.

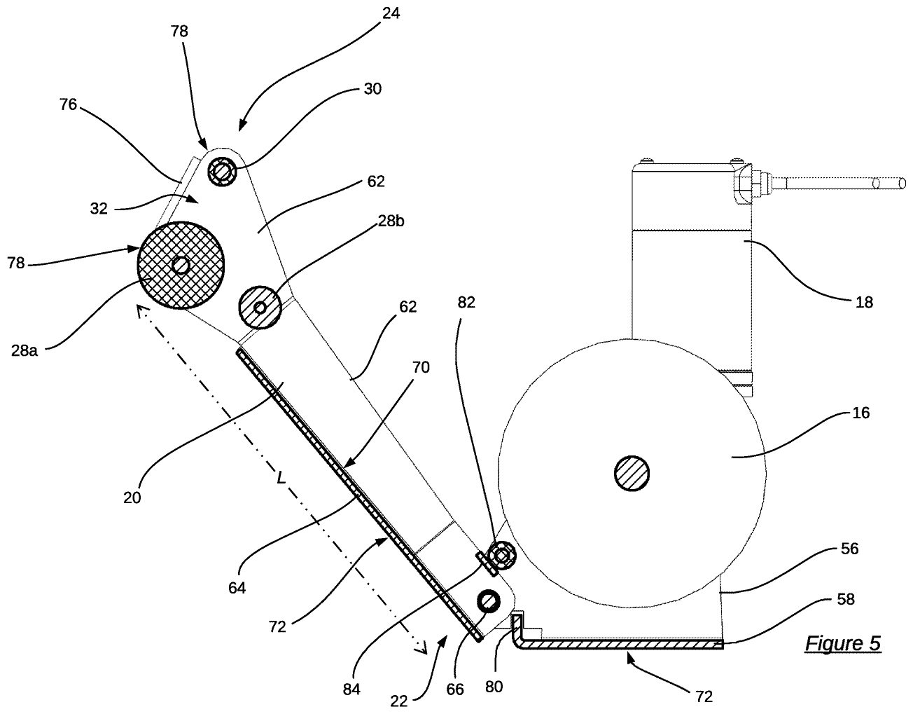

The boat winch assembly 10 also has a spar 20 with an inner end 22, an outer end 24. The spar 20 has a lengthwise direction extending from the inner end 22 to the outer end 24—the lengthwise direction is indicated in FIGS. 5 and 6 by double-headed arrows L.

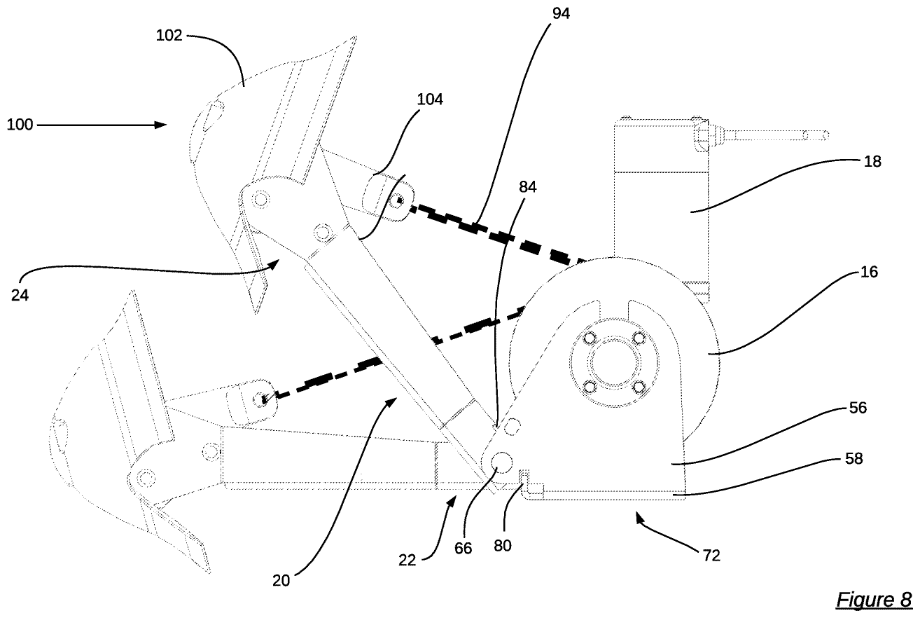

A hinge connection 26 is formed between the mounting bracket 12, and the inner end 22 of the spar 20, and is arranged such that the spar 20 projects outwardly from the hinge connection 26. The hinge connection 26 enables the spar 20 to rotate relative to the mounting bracket between a deployed position and a stowed position about a pivot axis P that is generally transverse to the lengthwise direction Z of the spar 20. In FIGS. 1 to 5, 9 and 10, the boat winch assembly 10 is illustrated with the spar 20 in the stowed position. In FIGS. 6, 7 and 11, the boat winch assembly 10 is illustrated with the spar 20 in the deployed position. FIG. 8 illustrates the boat winch assembly 10 and anchor 100, showing the spar 20 in the stowed position (with solid lines), and also overlaying the spar in the deployed position (indicated with broken lines in FIG. 8).

The outer end 24 of the spar 20 has rollers 28a, 28b, and an anchor line retaining member, which in this example is in the form of a removable pin 30. A fairlead 32 that is defined between the outermost roller 28a and the removable pin 30. In use of the boat winch assembly 10, the anchor line is to pass through the fairlead 32.

As shown in FIGS. 9 to 11, the boat winch assembly 10 can be mounted in the bow a boat 92, and with the pivot axis P above (or in close proximity to) the boat's prow/gunwale. When so mounted, inclination of the spar 20 increases with rotation of the spar 20 about the pivot axis P, from deployed position towards the stowed position. This has the benefit that the spar 20 (and anchor 100) can be placed in the stowed position, and so can reduce the likelihood of interference with a landing J when the boat 92 is tied up to the landing J, as illustrated in FIGS. 9 and 10. Hence, with the spar 20 in the stowed position a gap between the boat 92 and the landing J is substantially reduced, or even avoided. This has benefit to boat handlers and passengers embarking and disembarking over the bow of the boat 92.

As discussed in further detail below, when raising the anchor 100, the spar 20 will be in the deployed position while the anchor line 94 alone extends through the fairlead 32. Once the anchor 100 engages the fairlead 32, further winding of the anchor line 94 onto the spool 16, causes the spar 20 to be lifted towards the stowed position.

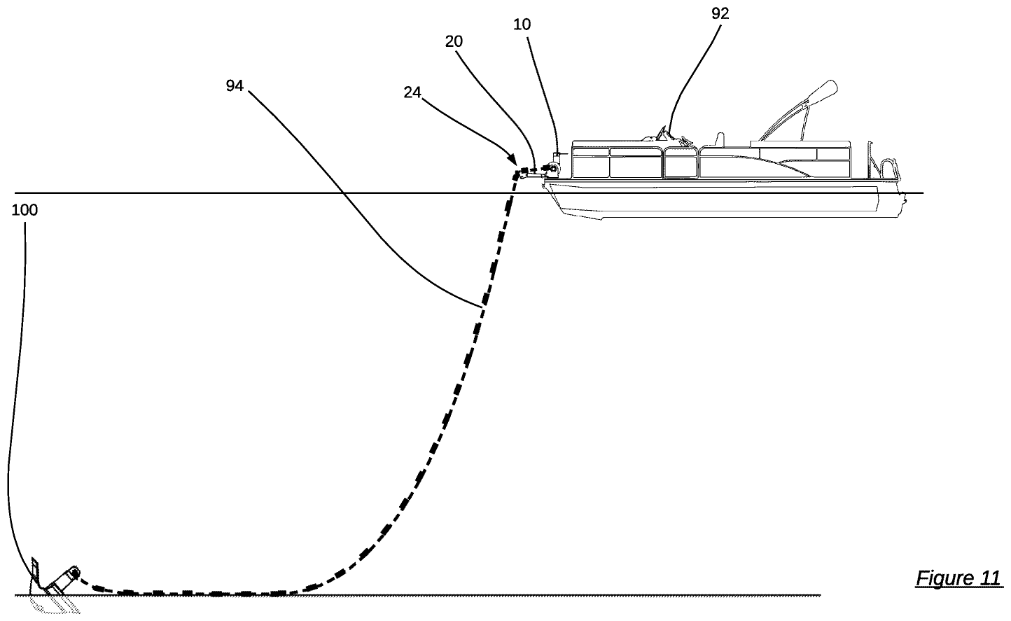

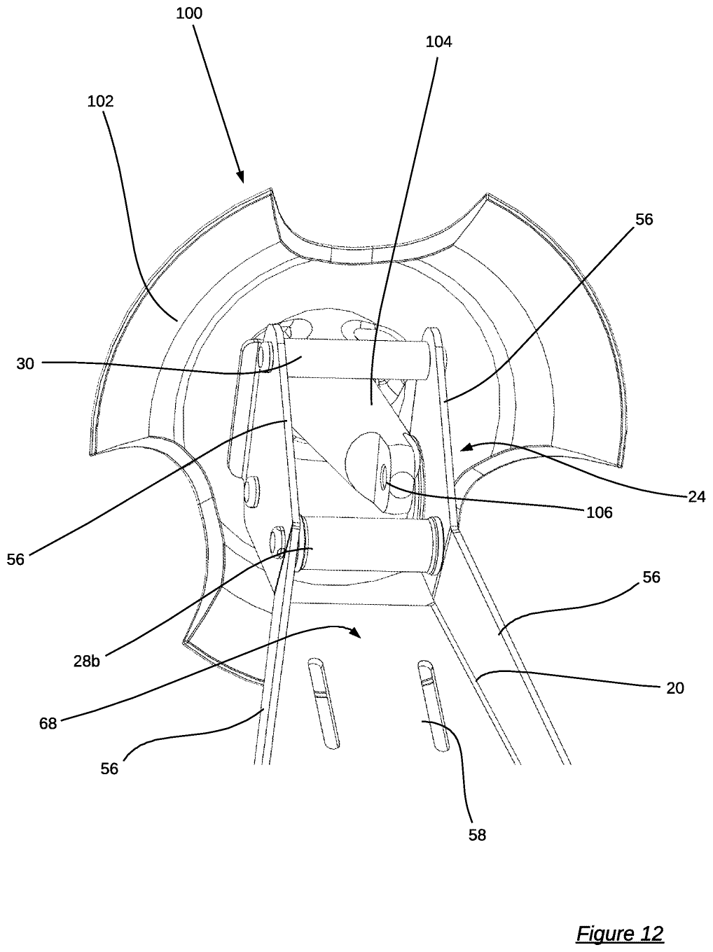

The boat winch assembly 10 is configured for mounting on a boat such that when the spar 20 in the deployed position, the outer end 24, and thus also the outermost roller 28a is outboard of the boat 92. This mounting is apparent from FIG. 11, which shows the boat winch assembly 10 mounted in the prow of the boat 92, and with the spar 20 in the deployed position. This arrangement facilitates keeping the anchor line 94 and anchor 100 clear of the boat hull and gunwale while raising and lowering of the anchor 100.

In this particular example, the spar 20 is displaceable through an angle of approximately 50° between the deployed and stowed positions, as indicated in FIG. 5 by angle a. The boat winch assembly 10 is arranged such that when the spar 20 is in the deployed position, the lengthwise direction Z of the spar 20 is generally parallel with the deck of the boat 92. In ordinary conditions, when the spar 20 is in its stowed position, gravity causes the spar 20 to move to the deployed position, absent any other forces acting on the spar 20.

In this particular example, the winch subassembly 14 also includes a gearbox 34. Within the gearbox housing are spur gears to reduce the rotational speed from the drive motor, and bevel gears to change the direction of rotation. The spool 16 has a shaft that extends into the gearbox 34. The housing of the gearbox 34 is bolted to the mounting bracket 12, and the housing of the drive motor 18 interconnects with the gearbox 34. The drive motor 18 can be an electric motor, as illustrated in the drawings.

It will be appreciated that the boat winch assembly 10 of the illustrated example (and/or of alternative examples) can be used with anchors of many different designs. However, for convenience the boat winch assembly 10 is illustrated and described with the anchor 100.

The anchor 100 has a head 102 that is connected to a shank 104. The shank 104 has a predetermined maximum diameter. The fairlead 32 is shaped to permit at least an upper end portion of the shank 104 to pass through the fairlead 32. The upper end portion of the shank 104 being the portion of the shank 104 that includes an attachment point for use in securing the anchor 100 to the anchor line 94. In this particular example, the entire length of the shank 104 is able to pass through the fairlead 32, as illustrated in FIGS. 1 and 12. In other examples, the anchor and boat winch assembly can be arranged such that only a part of the anchor-such as for instance, the upper end portion of the shank—can pass through the fairlead before interference prohibits further progress of the anchor/anchor line through the fairlead.

The outer end 24 of the spar 20 has an abutment formation that is configured such that the head 102 of the anchor 100 can abut the outer surface of the abutment formation, with the shank 104 extending through the fairlead 32. As will be appreciated, the drive motor 18 can be operated to wind the anchor line 94 onto the spool 16, and thus raise the anchor 100. In addition, when:
. the anchor 100 is in contact with the outer surface of the abutment formation,
. the shank 104 extends through the fairlead 32,
. the spar 20 is in its deployed position, and
d. the portion of the anchor line 94 that is between the spool 16 and the shank 104 is taut,
   operation of the drive motor 18 to wind anchor line 94 onto the spool 16 causes the spar 20 to move towards the stowed position. It will be appreciated that the same operation with the drive motor 18 can thus raise the anchor 100, and then lift the spar 20 from the deployed position to the stowed position. Once the spar 20, with the anchor 100, is positioned in the stowed position and with the anchor line 94 between the spool 16 and the shank 104 taut, the anchor 100 is thus conveniently stowed.

The mounting bracket 12 includes a pair of side walls 56 and a base plate 58, which extends between and spaces apart the side walls 56. The base plate 58 includes mounting holes 60 with which to secure the boat winch assembly 10 to a boat. An underside of the base plate defines a mounting surface 72 of the boat winch assembly 10. The spar 20 has a pair of uprights 62, and a centre plate 64, which extends between and spaces apart the uprights 62. Each upright 62 is on the lateral sides of the centre plate 64.

The assembly 10 includes a hinge pin 66 that interconnects the spar 20 and the mounting bracket 12 to thereby define the pivot axis P of the hinge connection 26. The hinge pin 66 extends between the side walls 56, and through knuckle holes (not shown) in the uprights 62 of the spar 20.

The centre plate 64 of the spar 20 includes an upper surface 68 and a lower surface 70 between the inner and outer ends 22, 24. The lower surface 70 is generally planar and parallel with the lengthwise direction L of the spar 20.

In this example, the boat winch assembly 10 is configured so that when the spar 20 is in the deployed position, the lower surface 70 is generally parallel to the base plate 58. Further, when the spar 20 is in the deployed position, the lower surface 70 is offset from the mounting surface 72 of the mounting bracket 12 (which is on the underside of the base plate 58). The offset has the lower surface 70 vertically above the mounting surface 72, as is shown in FIG. 6. This has the benefit that deflection of the spar 20 is less likely to result in contact between the spar 20 and the boat itself, which may occur when the spar 20 is subjected to the weight of the anchor 100 and anchor line 94, or when the spar is released from the stowed position so as to fall into the deployed position.

The uprights 62 are generally at right angles to the centre plate 64, and extend away from the upper surface 70 of the centre plate 64. In this way, a channel-like formation is defined by the upper surface 70, and the inwardly oriented faces of the uprights 62. The channel-like formation provides a means for containing the anchor line 94 when the anchor line 94 is slack between the spool 16 and the fairlead 32. As will be appreciated, containment of the anchor line 94 by the channel-like formation reduces the likelihood of the anchor line 94 snagging, or damaging the deck of the boat.

At the outer end 24 of the spar 20, outer portions of the uprights 62 project outwardly beyond the centre plate 64. The abutment formation is formed in part by the outer portions of the uprights 62. The rollers 28a, 28b and removable pin 30 are connected to the outer portions of the uprights 62. Further, the outer portion of each upright 62 includes an end face 74 that is partially oblique to the lengthwise direction L of the spar 20. As is evident from FIGS. 2 to 5, the end faces 74 are also generally orthogonal to the outer portions of the uprights 62.

The outer portion of each upright 62 includes a curved portion 76 adjacent the respective end face 74. The fairlead 32 is also defined between the two curved portions 76 (together with the outermost roller 28a and the removable pin 30).

FIG. 8 illustrates the head 102 of the anchor 100 in abutment with the abutment formation of the spar 20. In solid lines, the spar 20 is shown in its stowed position; this is overlayed with the spar 20 shown (by broken lines) in its deployed position. Further, the location of the anchor line 94 between the spool 16 and the shank 104, when taut, is indicated by lines 94 for each of the stowed and deployed positions.

The abutment formation of the spar 20 is configured such that, when the head 102 of the anchor 100 is in contact with the outer surface, and the shank 104 is extending through the fairlead 32, the shank 104 is inclined relative to the lengthwise direction of the spar 20. This inclination is substantially the same as the angle made by the taut portion of the anchor line 94 that is between the anchor 100 and the spool 16. In this example, the abutment formation includes the end faces 74, the outermost roller 28a, and contact points 78 on the two uprights 62. In particular, the outermost roller 28a, and the contact points 78 abut the surface of the head 102 of the anchor 100. It is these points of contact between the spar 20 and the anchor 100 that determine the inclination.

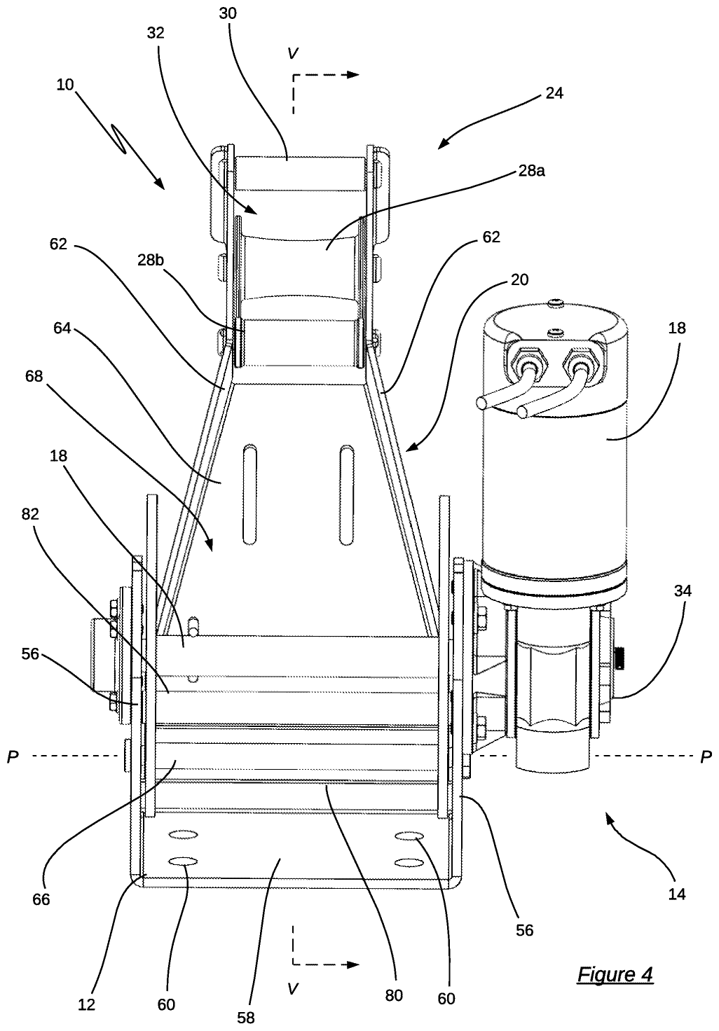

As shown particularly in FIG. 4, the width of the spar 20 narrows in the lengthwise direction towards the outer end 24 (and thus in the direction away from the hinge connection 26). This structure provides lateral stability to the outer end 24 of the spar 20.

The mounting bracket 12 has a first stop that engages with the spar 20 to limit rotation of the spar 20 in a first direction about the pivot axis P. Interference of the spar 20 with the first stop defines the deployed position. In the illustrated embodiment, the first stop is integrally formed with the mounting bracket 12. To this end, the first stop is formed by an upwardly projecting formation in the base plate 58 that creates a lip 80; the inner end 22 of the spar 20 engages with the lip 80 to inhibit rotation of the spar 20 past the deployed position.

To provide rigidity to the lip 80, the two side walls 56 of the mounting bracket 12 have notches into which the lip 80 locates. In this way, the side walls 56 act to brace the lip 80.

The mounting bracket also has a second stop that engages with the spar 20 to limit rotation of the spar 20 in a second direction about the pivot axis P. Interference of the spar 20 with the second stop defines the stowed position. In the illustrated embodiment, the second stop includes a bar 82 that extends between the side walls 56. As the spar 20 is held by the hinge pin 66 between the side walls 56, the spar 20 engages with the bar 82 to inhibit rotation of the spar 20 past the stowed position.

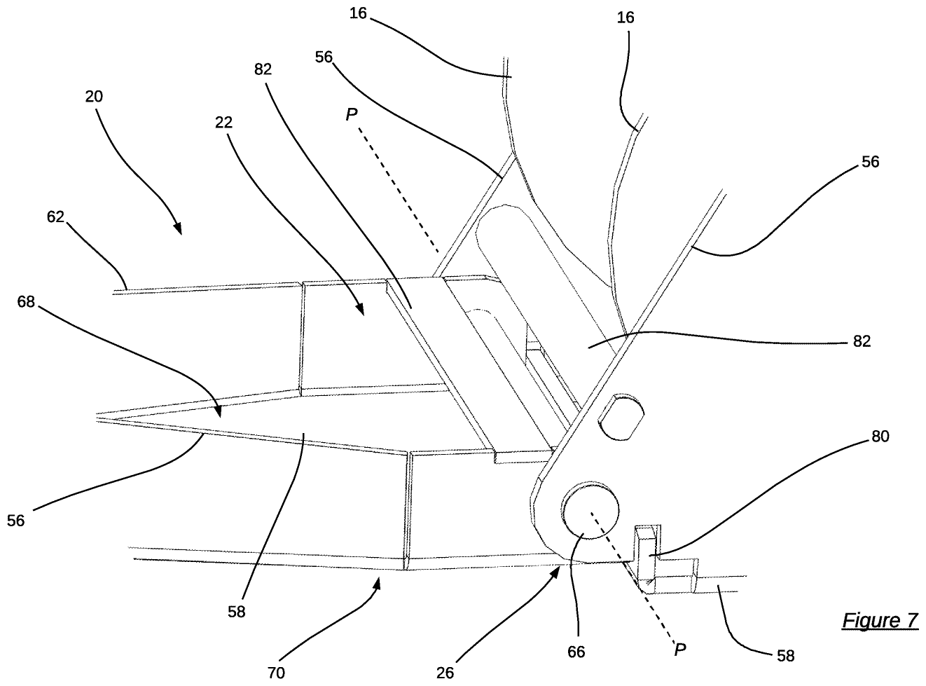

As shown in FIGS. 6 and 7, the spar 20 includes a stop plate 84 that is disposed to contact the bar 82 when the spar 20 is in the stowed position. The stop plate 84 is secured to the uprights 62, so as to provide a greater contact area with the bar 82. This provides rigidity to the spar 20, when the anchor line 94 pulls the spar 20 hard against the mounting bracket 12.

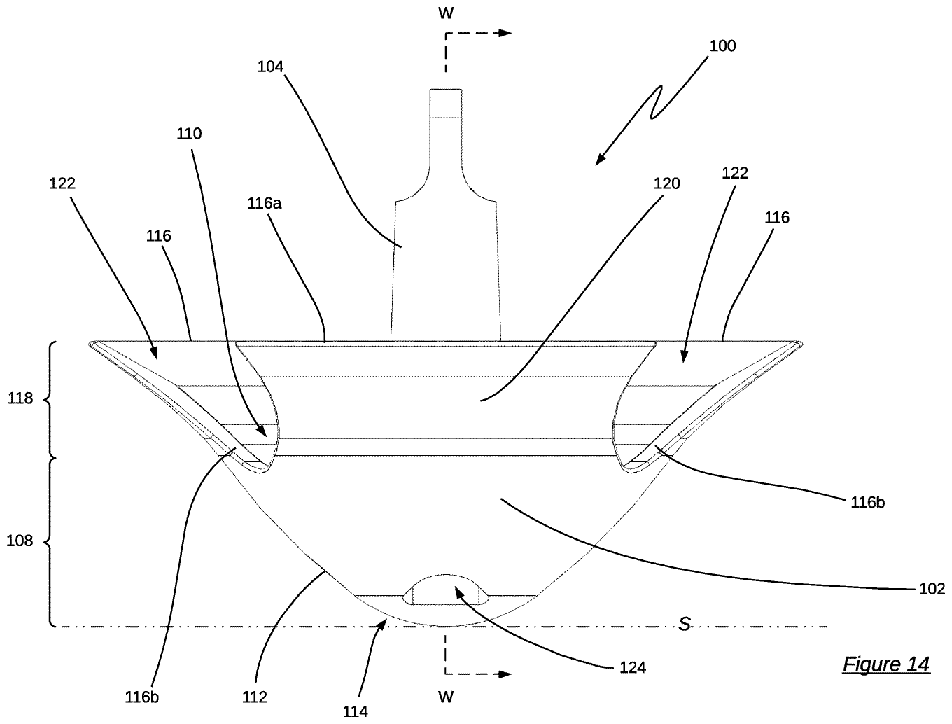

FIGS. 14 to 24 illustrate various aspects and features of the anchor 100. As is evident from the Figures, the shank 104 of the anchor 100 has an attachment point, which in this example is in the form of an eyelet 106, at its upper end for use in securing the anchor 100 to the anchor line 94. The head 102 includes a dome-shaped portion 108 at the lower end of the shank 104 (opposite the eyelet 106), and an inner surface 110 that faces towards the eyelet 106 end of the shank 104, and an outer surface 112. At least part of outer surface 112 is convex. The dome-shaped portion 108 defines part of the outer surface 112. The outer surface 112 faces outwardly with respect to the shank 104 and eyelet 106. As shown in FIGS. 14, 15, and 21 to 24, the outer surface 112 within the dome-shaped portion 108 is convex.

The anchor 100 is shaped to be unstable when placed on a horizontal planar surface, and with the shank 104 extending vertically. This unstable condition of the anchor 100 is illustrated in FIG. 14, in which dash-double dot line S represents schematically the horizontal planar surface.

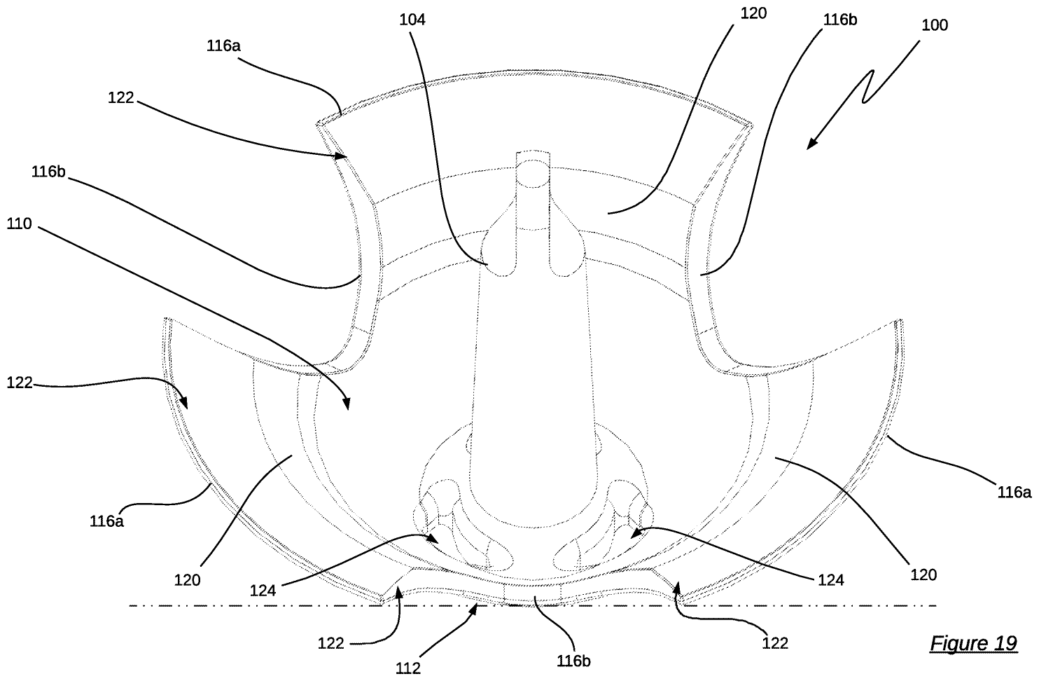

The anchor 100 is configured to have a stable condition when the outer surface 112 of the head 102 is in contact with a horizontal planar surface and with the shank 104 extending obliquely to vertical. This stable condition of the anchor 100 is illustrated in FIGS. 18 and 19, in which dash-double dot line S again represents schematically the horizontal planar surface.

In this example, the anchor 100 is further configured so that when placed on the horizontal planar surface S with the outer surface 112 in contact with that horizontal planar surface S and with the shank 104 extending vertically (in other words, in the unstable condition), the anchor 100 will roll on the outer surface 112 and then come to rest in the stable condition. This provides significant benefit in that the anchor 100 is predisposed to come to rest on the bed of a body of water in the stable condition, which allows for the anchor 100 to quickly take hold in the bed material.

The outer surface 112 of the head 102 includes a central region 114 that is opposite the shank 102. Within the central region 114, the curvature is such that the anchor 100 is unstable when placed on a horizontal planar surface S with the central region 114 contacting that horizontal planar surface S. As will be appreciated, the shape of the central region 114 enables the anchor 100 to be unstable, even when the shank 104 has an inclination to vertical that is less than the inclination when the anchor 100 is in its stable condition.

As shown in FIG. 18, the anchor 100 is configured such the radial centre of the outer surface 112 is not in contact with the horizontal planar surface S, when the anchor 100 is in the stable condition. In other words, the radial centre of the outer surface 112 is spaced from the horizontal planar surface S, when the anchor 100 is in the stable condition.

The anchor 100 is configured to be stable when the both the peripheral edge 116 of the head 102 and the outer surface 112 of the dome-shaped portion 108 are in contact with a horizontal planar surface S.

It will be appreciated that the anchor 100 being stable in the condition illustrated in FIG. 18 arises from the combination of characteristics of the outer surface 112, and the length and centre of mass properties of the shank 104.

As shown in FIGS. 18 and 19, the anchor 100 is configured so that a portion of the peripheral edge 116 of the head 102 is to contact with horizontal planar surface S when the anchor 100 is in the stable condition.

The head 102 includes a flared portion 118 that extends from the dome-shaped portion 108. Within the flared portion 118, the head 102 flares outwardly. The flared form of this portion of the head 102 is illustrated particularly in FIGS. 14, 15, 18, 21 and 23. The radially outer edge of the flared portion 118 corresponds with the peripheral edge 116 of the head 102.

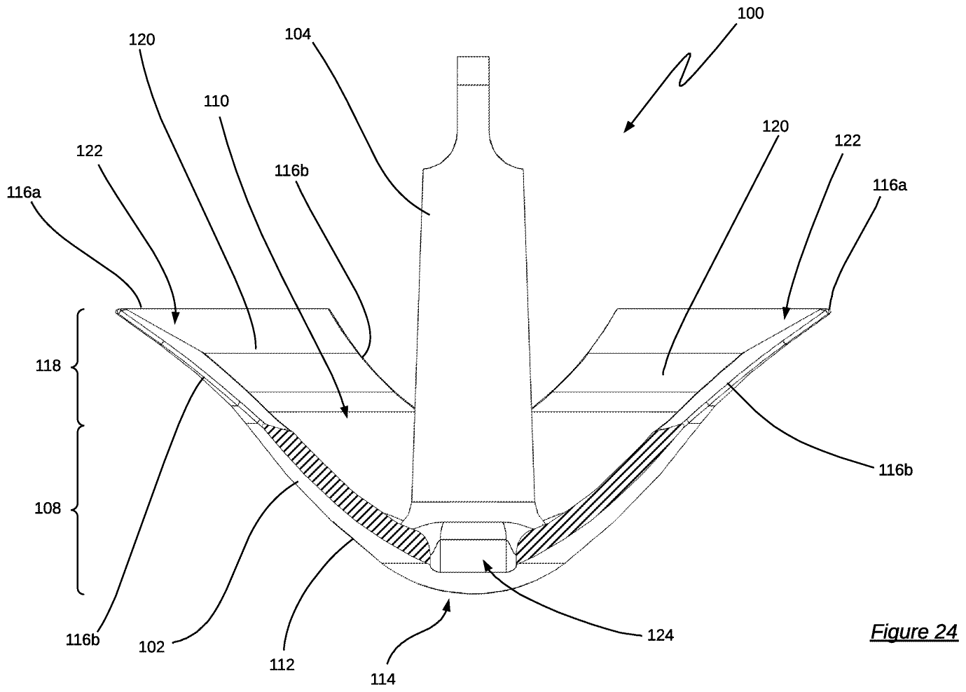

In this particular example, the outer surface 112 of the head 102 is defined by a cubic Bézier curve that is revolved around the longitudinal axis of the shank 104, with an inner end point of that curve coincident with that longitudinal axis. In FIG. 23, the longitudinal axis of the shank 104 is identified by dash-dot line L_{A}, and the cubic Bézier curve is identified by dashed line B_{C}. The longitudinal axis L_{A} of the shank 104 extends through the central region 114 of the outer surface 112.

It will be apparent that the dome-shaped portion 108 corresponds approximately with the part of the cubic Bézier curve B_{C} in which the concavity of the curve is in the direction of the shank 104; and that the flared portion 118 corresponds approximately with the part of the cubic Bézier curve B_{C} in which the concavity of the is away from the shank 104.

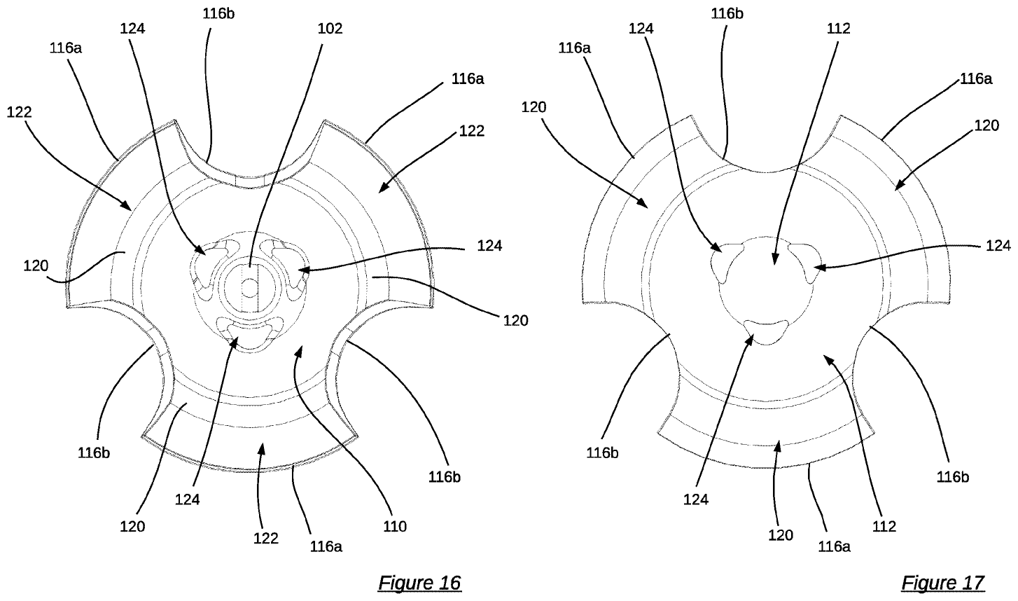

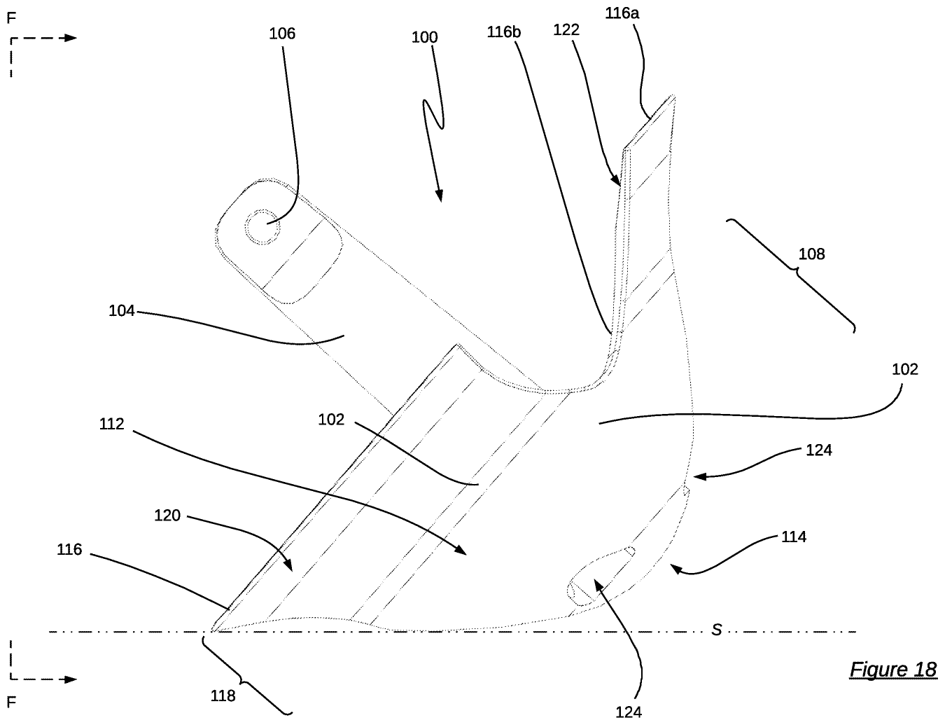

The head 102 is formed such the peripheral edge 116 includes radially outermost edge portions 116a, and indented portions 116b that are each disposed between an adjacent pairs of the radially outermost edge portions 116a. The arrangement of radially outermost edge portions 116a and indented portions 116b define fluke-like formations 120 in the head 102. In this particular example, the peripheral edge 116 has three radially outermost edge portions 116a and three indented portions 116b. Accordingly, there are three fluke-like formations 120 in the head 102. The indented portions 116b are equally spaced in the circumferential direction about the head 102, as is shown in FIGS. 16 and 17. The radially outermost edge portions 116a, and indented portions 116b alternate in the circumferential direction around the peripheral edge 116.

Each radially outermost edge portion 116a is a circular segment. This has the benefit of the encouraging the anchor 100 to adopt a stable configuration on a horizontal planar surface S in which two points of the peripheral edge 116 are in contact with that surface. Those two points are at the intersections of a respective one of the indented portions 116b with the two adjacent radially outermost edge portions 116a. This is beneficial in encouraging the anchor 100 to at least partially embed two of the fluke-like formations 120 in the bed material at the bottom of a body of water.

It will be appreciated that in this particular example between the fluke-like formations 120 the cubic Bézier curve B_{C} is truncated to define the actual outer surface 112 of the head 102.

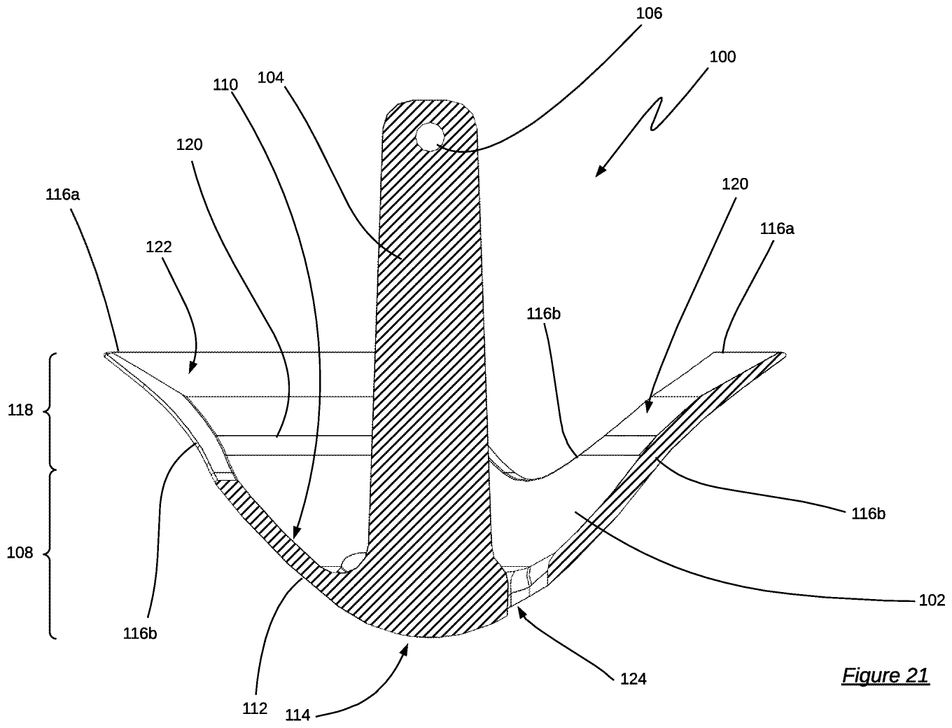

As is particularly evident from the cross-sectional views of FIGS. 21 to 24, the inner surface 110 of the dome-shaped portion 108 is concave in the direction of the eyelet 106 of the shank 102.

The thickness of the head 102 in the direction that is orthogonal to the outer surface 112 reduces towards the peripheral edge 116. More specifically, in this particular example, the thickness of the head 102 in the direction that is orthogonal to the outer surface 112 reduces in radially outer regions 122 that are adjacent the radially outermost edge portions 116a. Further, the inner surface 110 has a single bevel in each of the radially outer regions 122 to create a form similar to a chisel tip to each of the fluke-like formations 120. As shown in the drawings, the inner surface 110 of the head 102 has a deviation within the radially outer regions 122 such that the separation of the inner and outer surfaces 110, 112 reduces towards the radially outermost edge portions 116a.

The single bevel has the effect of guiding the fluke-like formations 120 into bed material as the anchor 100 is dragged along the bed by the anchor line 94 in use. This has the benefit of enhancing embedment depth in situations in which the anchor line 94 is pulled by the boat 92.

It will be appreciated that an outcome of the deeper embedment and higher holding power that can be achieved with the anchor 100 is that bed material is caught up on the internal side of the head 102, including within the dome-shaped portion 108. Lifting retained bed material with the anchor 100 during retrieval requires higher winching effort, compared with retrieval of the anchor 100 alone (in other words, when the anchor 100 is devoid of any bed material).

The head 102 of the anchor 100 includes discharge holes 124 that extend through the dome-shaped portion 108. The discharge holes 124 are beneficial in relieving suction between the head 102 and the bed material. In addition, the discharge holes 124 provide ports through which bed material can be discharged from, and thus evacuated, from the internal side of the head 102. The shape of the anchor 100 around the discharge holes 124 encourages water to flow through the discharge holes 124. During raising of the anchor 100, water flow through the discharge holes 124 entrains bed material that is on the internal side of the head 102, thereby discharging that bed material from the anchor 100.

As shown particularly in the cross-sectional views of the anchor 100, the inner surface 110 of the head 102 in portions surrounding each discharge hole 124 is chamfered.

Further, in this particular example:
each portion of the inner surface 110 that is between the shank 104 and each discharge hole 124 is curved and convex;
each portion of the inner surface 110 that extends between each pair of adjacent discharge holes 124 is curved and convex; and
each portion of the inner surface 110 that is adjacent each of the discharge holes 124 and is also radially outward of the shank 104 is curved and convex.

The curved and convex shape elements of these portions of the inner surface 110 surrounding the discharge holes 124 causes a local acceleration of water through the discharge holes 124. This enhances the entrainment of bed material into that flow of water, which in turn aids discharge.

In this example, the anchor 100 has three discharge holes 124. As particularly evident from FIGS. 16 and 17, the discharge holes 124 are equally spaced in the circumferential direction about the head 102. Further, the discharge holes 124 and the indented portions 116b are offset from one another in the circumferential direction. In other words, the fluke-like formations 120 and the discharge holes 124 are circumferential aligned.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A boat winch assembly comprising:
a mounting bracket for securing the assembly to a boat;
a winch subassembly that is supported by the mounting bracket, and includes a spool onto which an anchor line is to be wound, and a drive motor for rotating the spool;
a spar with an inner end, an outer end, and a lengthwise direction extending from the inner end to the outer end, the outer end of the spar having:
one or more rollers,
an anchor line retaining member, and
a fairlead that is defined between one of the rollers and the anchor line retaining member, whereby in use of the boat winch assembly, the anchor line is to pass through the fairlead; and
a hinge connection at the inner end of the spar that interconnects the spar with the mounting bracket, such that the spar projects outwardly from the hinge connection, the hinge connection enabling the spar to rotate relative to the mounting bracket between a deployed position and a stowed position about a pivot axis that is generally transverse to the lengthwise direction of the spar,
wherein, when the boat winch assembly is secured to a boat, inclination of the spar increases with rotation of the spar about the pivot axis from the deployed position towards the stowed position.

2. The boat winch assembly of claim 1, wherein the assembly is configured to be used with an anchor having a head connected to a shank with a predetermined maximum diameter, and wherein the fairlead is shaped to permit at least an upper end portion of the shank to pass through the fairlead.

3. The boat winch assembly of claim 2, wherein:
the outer end of the spar has an abutment formation that is configured such that the head of the anchor can abut an outer surface of the abutment formation with the shank extending through the fairlead; and
the assembly is configured such that, when:
the anchor is in contact with the outer surface of the abutment formation,
at least part of the shank extends through the fairlead,
the spar is in the deployed position, and
the portion of the anchor line that is between the spool and the shank is taut,
operation of the winch subassembly to wind anchor line onto the spool causes the spar to move towards the stowed position.

4. The boat winch assembly of claim 3, wherein the abutment formation is configured such that, when the head is in contact with the outer surface and the shank is extending through the fairlead, the shank is inclined relative to the lengthwise direction of the spar.

5. The boat winch assembly of claim 1, wherein the spar is displaceable about the pivot axis by at least 15° between the deployed and stowed positions.

6. The boat winch assembly of claim 1, wherein the assembly is configured such that when secured to a boat and with the spar in the stowed position, gravity causes the spar to move to the deployed position absent any other forces acting on the spar.

7. The boat winch assembly of claim 1, wherein the mounting bracket includes a pair of side walls and a base plate that extends between and spaces apart the side walls,
and wherein the hinge connection includes a hinge pin that extends between the side walls, and interconnects the spar and the mounting bracket to thereby define the pivot axis.

8. The boat winch assembly of claim 7, wherein the spar has a centre plate, and a pair of uprights, wherein each upright includes a knuckle hole through which the hinge pin extends.

9. The boat winch assembly of claim 8, wherein:
the centre plate has an upper surface and a lower surface between the inner and outer ends, the lower surface of the spar includes an inner end portion that is generally planar, the inner end portion of the lower surface is parallel to the base plate when the spar is in the deployed position,
the lower surface of the spar includes an inner end portion, and an underside of the base plate defines a mounting surface of the boat winch assembly, and
when the spar is in the deployed position the inner end portion is offset from the mounting surface.

10. The boat winch assembly of claim 8, wherein the outer end of the spar has an abutment formation that is configured such that the head of the anchor can abut the outer surface of the abutment formation, with the shank extending through the fairlead,
wherein outer portions of the uprights project in the lengthwise direction outwardly beyond the centre plate at the outer end of the spar, the outer portions at least partly forming the abutment formation, and
wherein the rollers and anchor line retaining member are interconnected with the outer portions of the uprights.

11. The boat winch assembly of claim 10, wherein the outer portion of each upright includes an end face that is partially oblique to the lengthwise direction of the spar, and a curved portion adjacent the end face,
and wherein the fairlead is partly defined by the curved portions, and/or the end faces.

12. The boat winch assembly of claim 1, wherein the mounting bracket has a first stop that engages with the spar to limit rotation of the spar in a first direction about the pivot axis to thereby define the deployed position.

13. The boat winch assembly of claim 1, wherein the mounting bracket has a second stop that engages with the spar to limit rotation of the spar in a second direction about the pivot axis to thereby define the stowed position.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The boat winch assembly of claim 12, wherein the first stop is integrally formed with the mounting bracket.

37. The boat winch assembly of claim 36, wherein the first stop is formed by an upwardly projecting lip formation in the base plate, and wherein the inner end of the spar engages with the lip formation to inhibit rotation of the spar past the deployed position.

38. The boat winch assembly of claim 13, wherein the second stop includes a bar that extends between the side walls.

39. The boat winch assembly of claim 10, wherein the spar includes a stop plate that is disposed to contact the bar when the spar is in the stowed position.

40. The boat winch assembly of claim 7, wherein the base plate includes mounting holes for use in securing the boat winch assembly to a boat.
